(19) United States
(12) Patent Application Publication
(10) Pub. No.: US 2019/0362109 A1
(43) Pub. Date: Nov. 28, 2019

(54) INFORMATION ACQUISITION SYSTEM, SHOPPING ASSISTANCE SYSTEM, INFORMATION ACQUISITION DEVICE, AND SHOPPING ASSISTANCE METHOD

(71) Applicant: Panasonic Intellectual Property Management Co., Ltd., Osaka (JP)

(72) Inventors: Suguru KOJIMA, Kanagawa (JP); Shinichi OKADA, Tokyo (JP); Masahiro KUMAGAWA, Hyogo (JP); Masahiro NAKANO, Tokyo (JP)

(21) Appl. No.: 16/417,865

(22) Filed: May 21, 2019

(30) Foreign Application Priority Data
May 28, 2018 (JP) 2018-101685

(51) Int. Cl. G06K 7/10; H04W 4/80

(52) U.S. Cl. CPC G06K 7/10178; H04W 4/80; G06K 7/10356

(57) ABSTRACT

An information acquisition system includes an inner wall, an outer wall, and an antenna. The inner wall includes a reflective layer which reflects a radio wave. A reading space is located on an inner side of the reflective layer. Reading of tag information from an RF tag attached to an item is performed in the reading space. The outer wall is disposed on an opposite side of the inner wall from the reading space. The antenna is configured to output the radio wave toward the reading space in order to communicate with the RF tag. Between the inner wall and the outer wall, a peripheral space is provided. The reflective layer of the inner wall has a hole. The hole penetrates through the reflective layer in a thickness direction of the reflective layer.

### CROSS-REFERENCE TO RELATED APPLICATION

The present application is based upon and claims the benefit of priority of Japanese Patent Application No. 2018-101685, filed on May 28, 2018, the entire contents of which are incorporated herein by reference.

### TECHNICAL FIELD

The present disclosure generally relates to information acquisition systems, shopping assistance systems, information acquisition devices, and shopping assistance methods. The present disclosure specifically relates to an information acquisition system, a shopping assistance system, an information acquisition device, and a shopping assistance method for acquiring information from an RF tag attached to an item.

### BACKGROUND ART

JP H05-89364 A (hereinafter referred to as “Document 1”) discloses a system (POS system) attempting to realize retail stores without clerks.

The system disclosed in Document 1 includes a basket and a transaction terminal apparatus. The basket allows goods to be put in. The basket includes a scanner configured to read goods information (goods data) and a transmission circuit configured to transmit the goods information to the outside. The transaction terminal apparatus includes a reception circuit configured to receive the goods information, a scale configured to measure a weight of the goods put in the basket, and a controller configured to compare weight data corresponding to the respective pieces of goods information with a measured value measured by the scale. When the measured value by the scale matches a total weight represented by the weight data, the transaction terminal apparatus performs a checkout process.

In the system described in Document 1, the scanner of the basket has to read goods information on an item of goods at a timing when a customer puts the item of goods in the basket.

To solve this problem, a technique for acquiring respective pieces of goods information on one or more goods in the basket from corresponding radio frequency (RF) tags attached to the one or more goods by using a radio wave output from an antenna is considered.

In this case, in order to prevent reading of goods information from an RF tag which is located outside the basket and which is not a target (misreading), for example, the one or more goods in the shopping basket are moved to a reading space in an inner wall, and in a state where the reading space is closed with at least one of the shopping basket or a shutter, the antenna outputs a radio wave, and by using the radio wave, the respective pieces of goods information are acquired from the corresponding RF tags attached to the one or more goods.

In this technique, however, at least one of the bottom panel and the shutter of the shopping basket has to be closed, and therefore, reading of RF information takes time.

### SUMMARY

In view of the foregoing, it is an object of the present disclosure to provide an information acquisition system, a shopping assistance system, an information acquisition device, and a shopping assistance method for reading tag information from an RF tag attached to an item in a short time while the reliability of reading of the tag information from the RF tag is improved.

An information acquisition system of one aspect of the present disclosure includes an inner wall, an outer wall, and an antenna. The inner wall includes a reflective layer which reflects a radio wave. A reading space is located on an inner side of the reflective layer. The reading space is a space for reading of tag information from an RF tag attached to an item. The outer wall is located on an opposite side of the inner wall from the reading space. The antenna is configured to output the radio wave toward the reading space in order to communicate with the RF tag. The reflective layer of the inner wall has at least one hole. The at least one hole connects the reading space to a peripheral space provided between the inner wall and the outer wall.

A shopping assistance system of another aspect of the present disclosure includes the information acquisition system and a checkout processing system. The checkout processing system is configured to perform checkout processing of one or more goods each defined as the item in the reading space.

An information acquisition device of still another aspect of the present disclosure is to be used in the information acquisition system. The information acquisition device includes the inner wall and the antenna. The reflective layer of the inner wall has the at least one hole. The at least one hole connects the reading space to the peripheral space.

A shopping assistance method of yet another aspect of the present disclosure includes acquiring respective pieces of goods information on one or more goods each defined as the item put in the reading space by using the information acquisition system. The shopping assistance method includes performing, based on the respective pieces of goods information, checkout processing of the one or more goods in the reading space by using a checkout processing system.

### BRIEF DESCRIPTION OF THE DRAWINGS

FIG. 1 is an exterior perspective view illustrating a counter desk to which a shopping assistance system according to one embodiment of the present invention is applied;

FIG. 2 is block diagram illustrating the shopping assistance system;

FIG. 3 is an exterior perspective view illustrating a guide of the shopping assistance system;

FIG. 4 is a partially cutaway perspective view illustrating a main part of an information acquisition system in the shopping assistance system;

FIG. 5A is a top view illustrating the guide, an antenna, and a spacer of the shopping assistance system, and FIG. 5B is a sectional view taken along line X1-X1 of FIG. 5A;

FIG. 6 is a top view illustrating part of the shopping assistance system;

FIGS. 7A to 7C are views illustrating an operation when a placement section is moved downward in the shopping assistance system;

FIGS. 8A and 8B are views illustrating an operation when a shutter is closed in the shopping assistance system;

FIGS. 9A and 9B are views illustrating an operation when the placement section is moved upward in the shopping assistance system;

FIGS. 10A to 10C are views illustrating an operation of a shopping assistance system according to a first variation of the one embodiment of the present invention;

FIGS. 11A to 11C are views illustrating an operation of a shopping assistance system according to a second variation of the one embodiment of the present invention; and

FIG. 12 is an exterior view illustrating a guide and an antenna of a shopping assistance system according to a fifth variation of the one embodiment of the present invention.

### DETAILED DESCRIPTION

(1) Schema

A shopping assistance system according to the present embodiment is a system, for assisting customers' shopping in retail stores, which is introduced into the retail stores. Examples of the retail stores include convenience stores, supermarkets, department stores, drugstores, electronics retail stores, home centers (hardware stores), and the like.

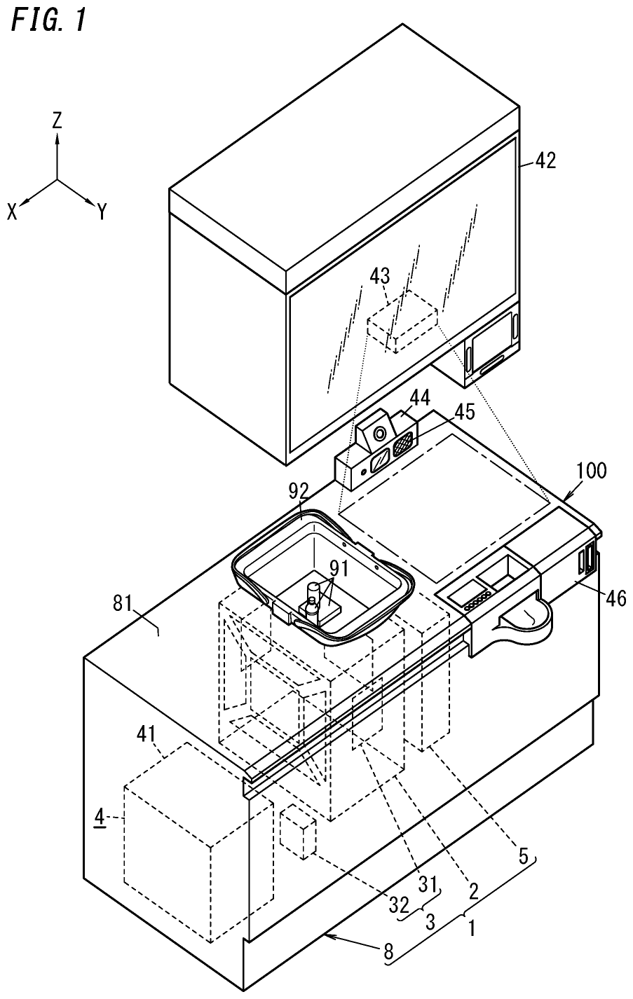

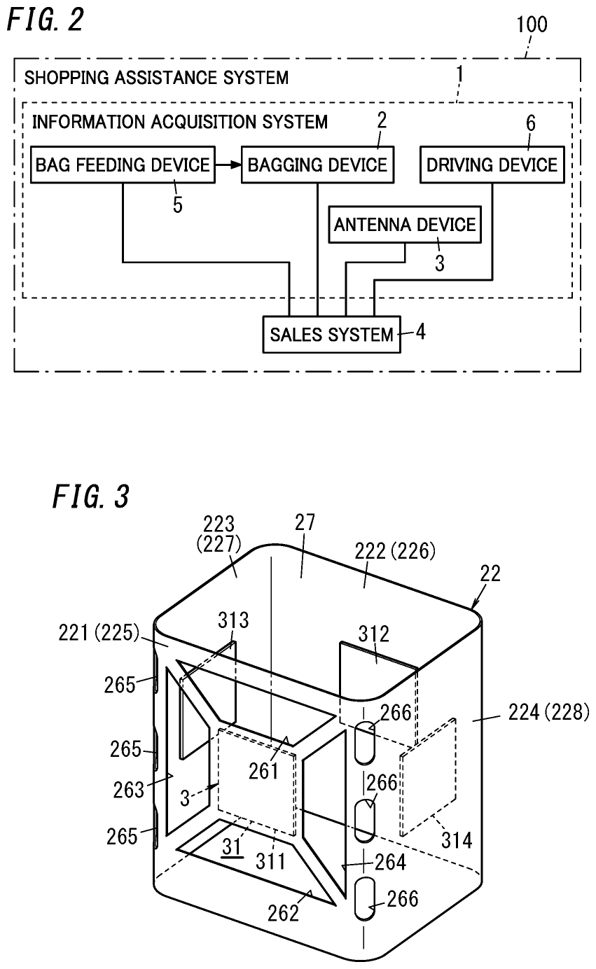

As illustrated in FIGS. 1 and 2, a shopping assistance system 100 includes an information acquisition system 1, a sales system 4 (checkout processing system), and a shopping basket 92. Note that the shopping basket 92 does not have to be a component included in the shopping assistance system 100.

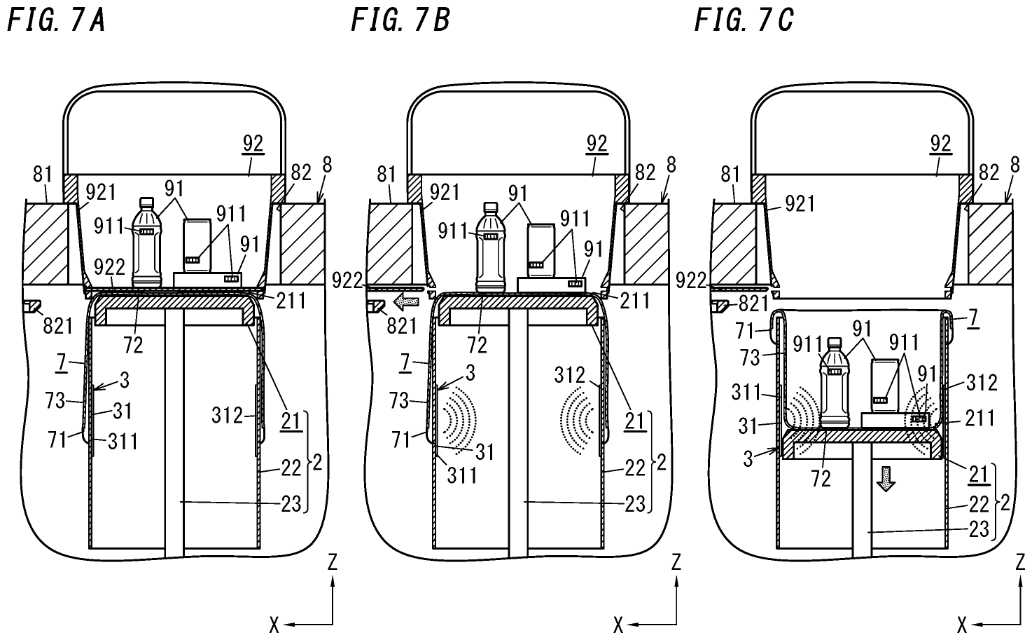

As illustrated in FIG. 1, the information acquisition system 1 includes a bagging device 2 (displacement device) configured to bag one or more goods 91 (items), an antenna device 3 configured to acquire respective pieces of goods information (tag information) on the one or more goods 91, a bag feeding device 5, and a counter desk 8. Herein, “bagging” means an operation of storing (putting) one or more goods 91 in a bag 7 (see FIG. 7A). It is only required that the bag has a dimension that allows the one or more goods 91 to be put in, and the bag has a bag opening through which each of the one or more goods 91 is put in or taken out. For example, the bag is a shopping bag (a so-called plastic shopping bag) made of polyethylene or polypropylene.

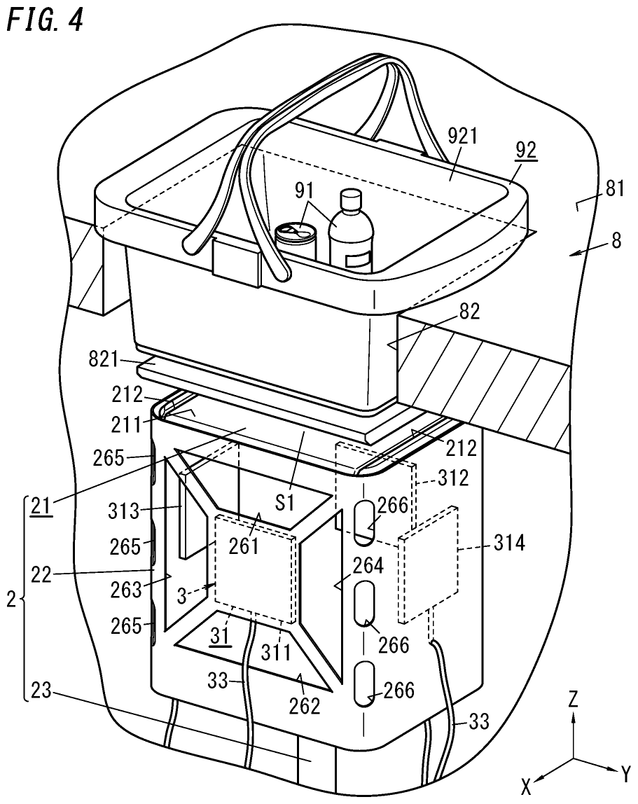

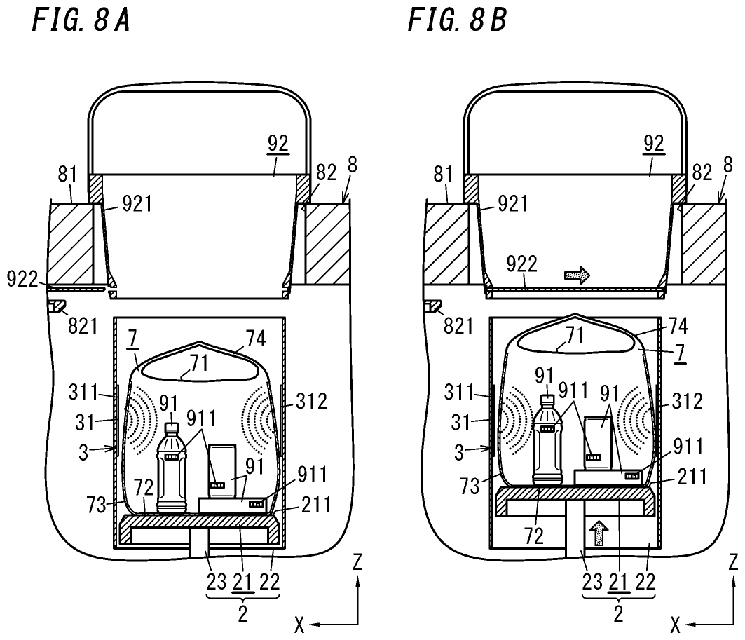

The bagging device 2 is configured to bag one or more goods 91 placed in a bagging space S1 (see FIG. 4) which is prescribed and defined on a placement surface 211 (see FIG. 4). The bagging device 2 is installed in, for example, a checkout counter in a store and is configured to move the one or more goods 91 put in the shopping basket 92, from the shopping basket 92 to the bag 7 (see FIG. 8A), thereby performing bagging of the one or more goods 91. Herein “bagging” means storing (putting) one or more goods 91 in any bag 7 which allows the one or more goods 91 to be put in. This allows customers to get the one or more goods 91 stored in the bag 7 by just placing the one or more goods 91 to be purchased in the bagging space S1. It is therefore possible for customers or store employees (clerks) to save labor and time needed for the bagging by using the bagging device 2.

The antenna device 3 is configured to acquire respective pieces of goods information on the one or more goods 91. The antenna device 3 reads the respective pieces of goods information from radio frequency (RF) tags 911 (see FIG. 7A) attached to the one or more goods 91, thereby acquiring the respective pieces of goods information. Herein, the “goods information” is information for identifying each of goods 91, and examples thereof in Japan include a goods (or product) identification code such as Japanese Article Number (JAN) code. In addition to the JAN code, examples of the goods identification code further include European Article Number (EAN) code in Europe, Universal Product Code (UPC) and Electric Product Code (EPC) in USA and the like.

In this embodiment, the antenna device 3 is configured to read the respective pieces of goods information when the bagging device 2 bags the goods 91. That is, the antenna device 3 reads the respective pieces of goods information from the RF tags 911 (see FIG. 7A) attached to the goods 91 during a read time period from a start of a bagging process by the bagging device 2 to release of the bag 7 storing the goods 91 from the bagging device 2. The antenna device 3 is configured also to transmit the respective pieces of goods information acquired to the sales system 4.

The sales system 4 is a system configured to perform a sales process of one or more goods 91. As used herein, a “sales process” refers to various processes required for actions (sales and purchase) of transferring the ownership of one or more goods 91 from a seller (store) to a buyer (customer) and paying the seller the consideration (charge) for the one or more goods 91 by the buyer. For example, the sales process includes an acquisition process, an order process, and the like. The acquisition process is a process of acquiring respective item information on one or more goods 91 picked up by a customer in a store. The order process is a process of receiving, from a customer, an order for one or more goods 91 which the customer wishes to buy.

In the shopping assistance system 100, the information acquisition system 1 and the sales system 4 are configured to operate in an interlocked manner with each other to realize the following functions.

That is, in a store into which the shopping assistance system 100 has been introduced, a customer picks up one or more goods 91 in the store, puts then in the shopping basket 92, places the shopping basket 92 in the bagging space S1 (see FIG. 4), and then, performs checkout and the like of the one or more goods 91 by using the sales system 4. At this time, the information acquisition system 1 acquires respective pieces of goods information by using the antenna device 3 while bagging the one or more goods 91 by using the bagging device 2. Then, the respective pieces of goods information acquired by the antenna device 3 are transmitted from the antenna device 3 to the sales system 4, and therefore, checkout and the like by using the sales system 4 becomes possible. This enables customers to finish shopping by a series of actions of picking up one or more goods 91, performing checkout of the one or more goods 91 by means of the sales system 4, and receiving the one or more goods 91 in a bagged state. Consequently, intervention by a clerk is no longer essential in a process of purchasing one or more goods 91 in a store by a customer. As a result, according to the shopping assistance system 100, it is possible to save clerks' labor and customers' labor, thereby reducing customers' shopping time.

(2) Details

The shopping assistance system 100 according to the present embodiment will be explained in detail below. In the present embodiment, a convenience store is exemplified as a store which the shopping assistance system 100 is introduced into. Moreover, in the present embodiment, a shopping bag (a so-called plastic shopping bag) made of polyethylene is an example of the bag 7. In this embodiment, a subject that places the one or more goods 91 in the bagging space S1 is not limited to a customer but may be a clerk. For example, when goods are packs of cigarettes or the like placed inside the checkout counter, a clerk, but not a customer, is to place the goods 91 in the bagging space S1.

(2.1) Shopping Assistance System

Herein, the overall structure of the shopping assistance system 100 according to the present embodiment will be first explained. As illustrated in FIGS. 1 and 2, the shopping assistance system 100 includes the information acquisition system 1, the sales system 4 (checkout processing system), and the shopping basket 92. The information acquisition system 1 has not only a function of acquiring the tag information from the RF tag 911 (see FIG. 7A) attached to each of the one or more goods 91 but also a function as a bagging system for bagging the one or more goods 91. The sales system 4 further has a function as a checkout processing system for performing checkout processing of the one or more goods 91 in the reading space 27 (see FIG. 3). Note that the shopping basket 92 does not have to be a component included in the shopping assistance system 100.

(2.2) Sales System

As illustrated in FIGS. 1 and 2, the sales system 4 includes a management device 41, a supply unit 42, a display device 43, an input device 44, a voice outputter 45, and a checkout unit 46. Each of the supply unit 42, the display device 43, the input device 44, the voice outputter 45, and the checkout unit 46 is a peripheral device of the management device 41 and is connected to the management device 41.

The management device 41 receives one or more pieces of goods information transmitted from the information acquisition system 1 (antenna device 3). Moreover, the management device 41 is configured to communicate with a store terminal including, for example, a point of sales (POS) terminal. In the management device 41, it is possible to perform checkout processing of the one or more goods 91 based on the one or more pieces of goods information received from the information acquisition system 1. Furthermore, the management device 41 is electrically connected to the bagging device 2 and the antenna device 3 in the information acquisition system 1 and is configured to control the bagging device 2 and the antenna device 3.

The supply unit 42 is configured to supply customers with one or more specific goods (e.g., cigarettes). The display device 43 is a device configured to display various kinds of information to customers. The input device 44 is a device configured to receive an operation performed by a customer through, for example, gesture detection. Moreover, the input device 44 includes a microphone and has a function of applying speech recognition and semantic analysis to a voice signal input from the microphone. Thus, a voice operation (voice input) by a customer is also possible. The voice outputter 45 includes a loudspeaker and is configured to provide customers with various kinds of information by the voice.

That is, the sales system 4 uses the display device 43, the input device 44, and the voice outputter 45 as user interfaces to provide customers with various kinds of information by the display or the voice and to receive operations (including voice input) by the customers. Note that such information may be represented by any one of the display and the voice, or represented by a combination of the display and the voice by the sales system 4.

The supply unit 42 is suspended from a ceiling to be provided above the counter desk 8. The display device 43 is fixed to a lower surface of the supply unit 42 and is configured to project an image onto a screen by, for example, a projection mapping technique. Herein, the display device 43 projects an image onto a region on the right of a recess 82 (see FIG. 4) in an upper surface 81 of the counter desk 8 as viewed from the front side of the counter desk 8. That is, the region on the right of the recess 82 in the upper surface 81 of the counter desk 8 serves as the screen of the display device 43. The input device 44 is disposed on the upper surface 81 of the counter desk 8 on a rear side of the screen as viewed from the front side of the counter desk 8. The input device 44 is provided integrally with the voice outputter 45.

(2.3) Shopping Basket

As illustrated in FIGS. 4 and 7A, the shopping basket 92 includes a basket body 921 and a bottom panel 922 and allows one or more goods 91 to be put therein. The basket body 921 has an opening at its bottom. The bottom panel 922 is slidable between an open position and a closed position closing the bottom (lower opening) of the basket body 921. That is, the bottom panel 922 is attached to the basket body 921 so as to allow the bottom of the basket body 921 to be opened and closed. Thus, the bottom of the basket body 921 becomes openable and closeable, and this enables the one or more goods 91 put in the shopping basket 92 to be released through the bottom of the basket body 921.

(2.4) Information Acquisition System

As illustrated in FIGS. 1 and 2, the information acquisition system 1 includes the bagging device 2, the antenna device 3, the bag feeding device 5, a driving device 6, and the counter desk 8. The bagging device 2 and the antenna device 3 form an information acquisition device.

In the following description, the counter desk 8 is installed in an orientation in which the upper surface 81 of the counter desk 8 is a horizontal surface unless otherwise noted. That is, a direction orthogonal to the upper surface 81 of the counter desk 8 is the up-and-down direction (vertical direction). Moreover, in the following description, the width direction (left-and-right direction) of the counter desk 8 is the “X-axis direction”, the depth direction (forward-and-rearward direction) of the counter desk 8 is the “Y-axis direction”, and the up-and-down direction (vertical direction) of the counter desk 8 is the “Z-axis direction”. That is, the X-axis direction, the Y-axis direction, and the Z-axis direction are directions orthogonal to one another. Moreover, when a positive orientation and a negative orientation in the Z-axis direction are distinguished from each other, the directions in FIG. 1 are used as references, and description is given provided that the positive orientation in the Z-axis direction is the “upward direction” and the negative orientation in the Z-axis direction is the “downward direction”. Similarly, when a positive orientation and a negative orientation in the X-axis direction are distinguished from each other, the directions in FIG. 1 are used as references, and description is given provided that the positive orientation in the X-axis direction is the “leftward direction” and the negative orientation in the X-axis direction is the “rightward direction”. Similarly, when a positive orientation and a negative orientation in the Y-axis direction are distinguished from each other, description is given provided that the positive orientation in the Y-axis direction is the “forward direction” the negative orientation in the Y-axis direction is the “rearward direction”. In the figures, arrows indicating the “X-axis direction”, the “Y-axis direction”, and the “Z-axis direction” are shown for the sake of explanation and are not accompanied with entity. Note that these directions are not to limit the directions of the shopping assistance system 100 in use. For example, the shopping assistance system 100 may be used with the upper surface 81 of the counter desk 8 being slightly tilted to a horizontal surface.

(2.5) Bagging Device

As illustrated in FIG. 4, the bagging device 2 includes a placement section 21, a guide 22 and an elevator unit 23 (driver). The placement section 21 and the guide 22 form an inner wall.

The placement section 21 has a rectangular plate shape. The placement section 21 has an upper surface serving as a placement surface 211 on which one or more goods 91 are to be mounted. In this embodiment, the placement surface 211 has a rectangular shape having rounded corners. Moreover, the placement surface 211 is preferably made of a resin. The placement surface 211 may be made of a material (e.g., metal) which absorbs or reflects radio waves output from the antenna 31.

As illustrated in FIGS. 3 and 4, the guide 22 has the reading space 27 (see FIG. 3) therein. The reading space 27 is a space in which reading of tag information from the RF tag 911 (see FIG. 7A) attached to each of the one or more goods 91 is performed. More specifically, the guide 22 is in a shape of a cylinder. Of an upper surface and a lower surface of the cylinder, at least the upper surface is an opening. In the present embodiment, the guide 22 is in a shape of a rectangular cylinder. Both an upper surface and a lower surface of the rectangular cylinder are openings. The opening surface of the guide 22 is slightly larger than the placement surface 211, and the guide 22 is disposed around the placement section 21 along an outer periphery of the placement surface 211. In this embodiment, the shape of an inner peripheral edge of an upper end surface of the guide 22 and the shape of the outer periphery of the placement surface 211 are in a similarity relationship.

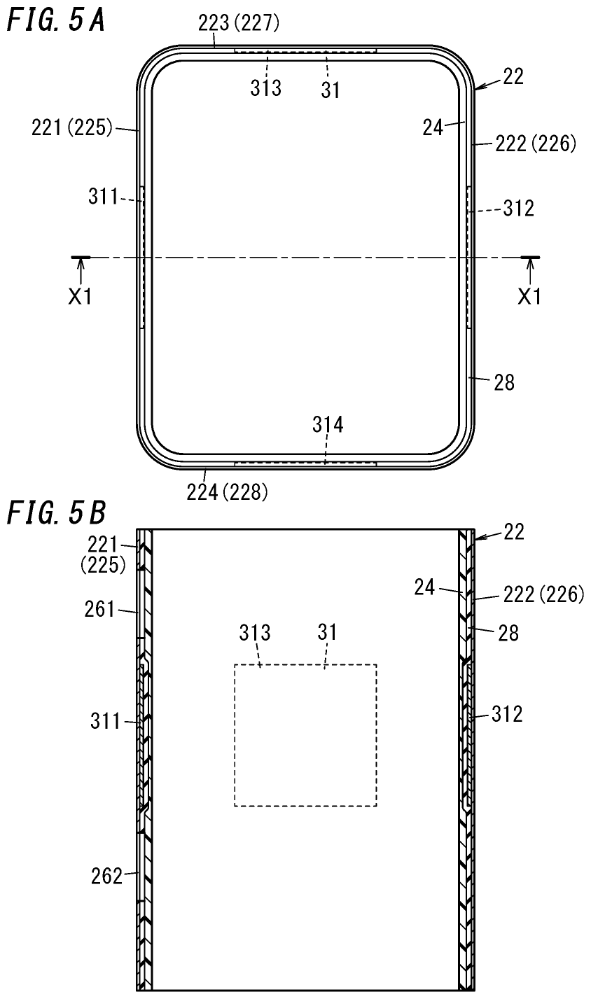

The guide 22 includes a plurality of (in the example shown in the figure, four) side walls 221 to 224 (see FIG. 3). The plurality of side walls 221 to 224 respectively also serve as reflective layers 225 to 228 which reflect radio waves. As illustrated in FIGS. 3, 5A, and 5B, the reflective layers 225 to 228 are inner surfaces facing the reading space 27. Between the reading space 27 and each of the reflective layers 225 to 228, a spacer 24 and a radio wave absorption member 28 which will be described later are provided. The plurality of side walls 221 to 224 correspond, on a one-to-one basis, to a plurality of patch antennas 311 to 314 which will be described later. Each of the patch antennas 311 to 314 is attached to a corresponding one of the side walls 221 to 224. Note that the reflective layers 225 to 228 are the inner surfaces directly facing the reading space 27 when the spacer 24 and the radio wave absorption member 28 are not disposed.

Among the plurality of side walls 221 to 224, the side wall 221 has a plurality of (in the example shown in the figure, four) holes 261 to 264. The plurality of holes 261 to 264 are formed in the periphery of a location to which the patch antenna 311 is attached. More specifically, the hole 261 is formed above the patch antenna 311. The hole 261 has, for example, a trapezoidal shape whose width in a lateral direction orthogonal to the up-and-down direction increases as the distance from the patch antenna 311 increases (as the distance to an upper edge of the side wall 221 decreases). The hole 262 is formed below the patch antenna 311. The hole 262 has, for example, a trapezoidal shape whose width in the lateral direction orthogonal to the up-and-down direction increases as the distance from the patch antenna 311 increases (as the distance to a lower edge of the side wall 221 decreases). The hole 263 is formed on the left of the patch antenna 311. The hole 263 has, for example, a trapezoidal shape whose width in the up-and-down direction increases as the distance from the patch antenna 311 increases (as the distance to a left edge of the side wall 221 decreases). The hole 264 is formed on the right of the patch antenna 311. The hole 264 has, for example, a trapezoidal shape whose width in the up-and-down direction increases as the distance from the patch antenna 311 increases (as the distance to a right edge of the side wall 221 decreases). Note that the side walls 222 to 224 preferably have similar holes.

The four holes 261 to 264 include first holes and second holes. The holes 261 and 262 are the first holes, and in a first direction (up-and-down direction) orthogonal to a direction in which the patch antenna 311 and the patch antenna 312 face each other, the holes 261 and 262 are formed on opposing sides of the location to which the patch antenna 311 is attached. That is, in the first direction, the patch antenna 311 is located between the hole 261 and the hole 262. The holes 263 and 264 are second holes, and in a second direction (left-and-right direction) orthogonal to both the first direction and the direction in which the patch antenna 311 and the patch antenna 312 face each other, the holes 263 and 264 are formed on opposing sides of the location to which the patch antenna 311 is attached. That is, in the second direction, the patch antenna 311 is located between the hole 263 and the hole 264.

Moreover, a plurality of (in the example shown in the figure, three) holes 265 are formed in an interface section between the side wall 221 and the side wall 223. The plurality of holes 265 are formed at the interface section between the side wall 221 and the side wall 223 to be arranged in the up-and-down direction. Each hole 265 has a shape elongated in the up-and-down direction.

Similarly, a plurality of (in the example shown in the figure, three) holes 266 are formed in an interface section between the side wall 221 and the side wall 224. The plurality of holes 266 are formed at the interface section between the side wall 221 and the side wall 224 to be arranged in the up-and-down direction. Each hole 266 has a shape elongated in the up-and-down direction. Note that in an interface section between the side wall 222 and the side wall 223 and in an interface section between the side wall 222 and the side wall 224, similar holes are preferably formed.

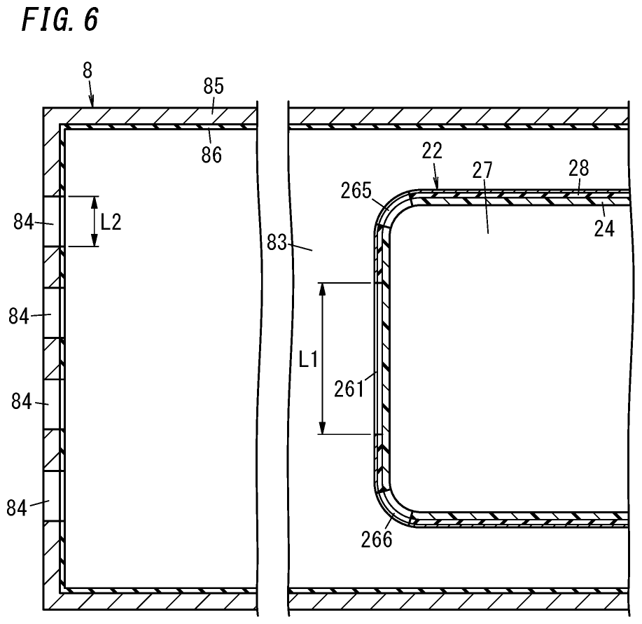

The holes 261 to 266 are formed, as described above, in the guide 22 and connect the reading space 27 to a peripheral space 83 (see FIG. 6) which will be described later. That is, the reading space 27 is in communication with the peripheral space 83, and a radio wave output from the antenna 31 to the reading space 27 easily leaks to the peripheral space 83 through the holes 261 to 266.

In the present embodiment, the length L1 (see FIG. 6) of each of the holes 261 to 266 is longer than ½ of the wavelength of the radio wave output from the antenna 31. Herein, the length L1 of each of the holes 261 to 266 means a maximum width dimension of width dimensions of opening surfaces of the holes 261 to 266. That is, when each of the holes 261 to 266 is a trapezoidal opening, the length of the longest one of the upper base and the lower base of the opening surface is the length L1 of each of the holes 261 to 266. When each of the holes 261 to 266 is a round opening, the length of the diameter of the opening surface is the length L1 of each of the holes 261 to 266. Note that in the case of the trapezoidal opening, each of the lengths of the upper base, the lower base, and the legs of the opening surface is preferably longer than ½ of the wavelength of the radio wave.

As illustrated in FIGS. 5A and 5B, the bagging device 2 further includes the spacer 24 (insulating layer) and the radio wave absorption member 28.

The spacer 24 is provided to the guide 22 to be located on a side facing the reading space 27. More specifically, the spacer 24 is made of an insulating synthetic resin such as an ABS resin and is provided to all over an inner periphery of the guide 22. The patch antennas 311 to 314 of the antenna 31 are disposed between the guide 22 and the spacer 24. In order to prevent the one or more goods 91 from falling through the holes 261 to 266 (see FIG. 3), the spacer 24 (insulating layer) preferably has no holes. Note that the spacer 24 is not necessarily provided to all over the inner periphery of the guide 22. The spacer 24 may be provided to only part of the inner periphery of the guide 22. The bagging device 2 does not have to include the spacer 24.

The radio wave absorption member 28 is provided on the guide 22. More specifically, the radio wave absorption member 28 is made of, for example, a magnetic material such as ferrite. The radio wave absorption member 28 is disposed between the guide 22 and the spacer 24. The radio wave absorption member 28 has an absorption function of absorbing the radio wave output from the antenna 31 to the reading space 27. The radio wave absorption member 28 preferably has holes similar to the holes 261 to 266 (see FIG. 3). For example, a plurality of holes in the radio wave absorption member 28 correspond to the holes 261 to 266 on a one-to-one basis and are located at the same locations as the corresponding holes 261 to 266. Note that the bagging device 2 does not have to include the radio wave absorption member 28.

As illustrated in FIGS. 5A and 5B, the spacer 24 is disposed on an inner side of the guide 22. Therefore, it is possible to reduce contacts between the RF tag 911 (see FIG. 7A) and each of conductors (the guide 22 and the antenna 31). It is also possible to reduce contacts between the RF tag 911 and the radio wave absorption member 28. Thus, it is possible to increase the reading ratio of goods information from the RF tag 911.

As illustrated in FIG. 4, the elevator unit 23 is configured to change the relative positional relationship between the placement section 21 and the guide 22 from a first state to a second state. In the present embodiment, a state where the placement section 21 is located at the upper end of the guide 22 is defined as the first state. When the relative positional relationship between the placement section 21 and the guide 22 is in the first state, the upper surface (placement surface 211) of the placement section 21 is located at a slightly higher level than the upper end surface of the guide 22. Thus, in the first state, the placement section 21 is disposed to close the opening in the upper surface of the guide 22. The position of the placement section 21 relative to the guide 22 in the second state is at a lower level than in the first state.

In other words, the placement section 21 moves relative to the guide 22 in the reading space 27 surrounded by the guide 22. In the present embodiment, the elevator unit 23 is configured to move downward only the placement section 21 of the placement section 21 and the guide 22, thereby changing the relative positional relationship between the placement section 21 and the guide 22 from the first state to the second state. That is, the placement section 21 is configured to move in the guide 22 which is tubular and which is fixed at a fixed position in the up-and-down direction by the elevator unit 23.

More specifically, the elevator unit 23 includes an electric motor (motor). The elevator unit 23 is realized by an appropriate mechanism which enables straight movement of the placement section 21 in the up-and-down direction by driving force generated by the electric motor of, for example, a pantograph type or a rack and pinion type.

In the present embodiment, as illustrated in FIG. 4, the bagging device 2 includes a pair of holding mechanisms 212 for holding the bottom part 72 (see FIG. 7A) of the bag 7 on the placement surface 211 in addition to the placement section 21, the guide 22, and the elevator unit 23. The holding mechanism 212 clamps the bottom part 72 of the bag 7 to hold the bottom part 72. At least while the relative positional relationship between the placement section 21 and the guide 22 changes from the first state to the second state, the bagging device 2 keeps the bottom part 72 of the bag 7 held on the placement surface 211 by the holding mechanism 212. Specifically, a pair of grooves (see FIG. 4) extending along the X-axis direction is formed on opposing ends in the Y-axis direction of the upper surface (placement surface 211) of the placement section 21. The holding mechanism 212 is formed in each of the pair of grooves and clips the bottom part 72 fit in the groove to hold the bottom part 72 in the groove. The bottom part 72 is fit in the groove by, for example, a fin protruding downward from a lower surface of a shutter 821.

The bagging device 2 is configured to perform bagging of the one or more goods 91 in the shopping basket 92. That is, a customer picks up one or more goods 91 in a store, puts them in the shopping basket 92, and places the shopping basket 92, in which the one or more goods 91 have been put, in the bagging space S1 which will be described later. In this way, it is possible to cause the bagging device 2 to bag the one or more goods 91. Thus, a customer does not have to take each of the one or more goods 91 out of the shopping basket 92 to bag it, and it is possible to easily perform the bagging of the one or more goods 91 by using the bagging device 2. When a plurality of goods 91 are put in the shopping basket 92, the bagging device 2 is capable of collectively bag the plurality of goods 91. In the present embodiment, the management device 41 controls the information acquisition system 1 in an interlocked manner with the sales system 4 so that the bagging of the one or more goods 91 and reading of respective pieces of goods information on the one or more goods 91 are performed while a customer performs the order process or the like by the sales system 4. For example, when triggered by a start of the order process by the sales system 4, the information acquisition system 1 starts bagging the one or more goods 91 and reading the respective pieces of goods information on the one or more goods 91.

(2.6) Antenna Device

As illustrated in FIGS. 3 and 4, the antenna device 3 is configured to read goods information from the RF tag 911 (see FIG. 7A) attached to each of the one or more goods 91 during the read time period to acquire the goods information. Herein, “read time period” is a time period during which the antenna device 3 reads the goods information, and the “read time period” is a time period after a start of the bagging process by the bagging device 2 until the bag 7 accommodating the one or more goods 91 are released from the bagging device 2. That is, the antenna device 3 is configured to read respective pieces of goods information on the one or more goods 91 from the corresponding RF tags 911 attached to the one or more goods 91 during a period (read time period) from a start of bagging the one or more goods 91 by the bagging device 2 to release of the one or more goods 91.

In the present embodiment, the RF tags 911 store the respective pieces of goods information. The antenna device 3 is configured to perform wireless communication with the RF tags 911 to read the respective pieces of goods information from the RF tags 911. In sum, in the shopping assistance system 100 of the present embodiment, the antenna device 3 does not directly read the respective pieces of goods information from the one or more goods 91 but reads the respective pieces of goods information from the RF tags which are the RF tags 911 attached to the one or more goods 91 in a non-contact manner.

Herein “RF tag” is, for example, a passive-type RF tag and has memory for storing at least goods information. Herein, the plurality of RF tags 911 are associated with the plurality of goods 91 on a one-to-one basis. Each RF tag 911 stores a piece of goods information on a corresponding one of the goods 91. Each RF tag 911 is attached to a corresponding one of the goods 91.

The RF tags 911 are attached to the goods 91 at least in a state where the RF tags 911 are handleable together with the goods 91. Various methods are available for attachment of the RF tags 911 to the goods 91. In the present embodiment, for example, the RF tags 911 are formed as seals and are put on the goods 91. Alternatively, for example, the RF tags 911 may be connected to the goods 91 by strings or the like, may be integrated with wrapping materials of the goods 91, or may be incorporated into the goods 91.

As illustrated in FIG. 3, the antenna device 3 includes the antenna 31 and a device body 32 (see FIG. 1). The antenna 31 is configured to communicate with the RF tags 911 (see FIG. 7A). The antenna device 3 is a reader-writer included in the radio frequency identification (RFID) system.

The antenna 31 is disposed on the guide 22 of the bagging device 2 and outputs a radio wave toward the reading space 27 to communicate with the RF tag 911. In the present embodiment, the antenna 31 includes a plurality of (in the example shown in the figure, four) patch antennas 311 to 314 disposed on an inner side surface of the guide 22. Each of the plurality of patch antennas 311 to 314 is preferably configured as an antenna for a circularly polarized wave when polarization is concerned. Note that each of the plurality of patch antennas 311 to 314 may be configured as an antenna for an elliptically polarized wave. Alternatively, the plurality of patch antennas 311 to 314 may be configured as antennas for linearly polarized waves and may have polarizations different from each other. Note that the patch antenna 311 corresponds to a first patch antenna, the patch antenna 312 corresponds to a second patch antenna, the patch antenna 313 corresponds to a third patch antenna, and the patch antenna 314 corresponds to a fourth patch antenna.

The plurality of patch antennas 311 to 314 are respectively disposed on the plurality of side walls 221 to 224 forming the guide 22 having a rectangular cylindrical shape. The patch antennas 311 and 312 face each other, and the patch antennas 313 and 314 face each other. The plurality of patch antennas 311 to 314 each have directivity. The plurality of patch antennas 311 to 314 are arranged such that directions of the directivity are different from each other. Each of the plurality of patch antennas 311 to 314 is electrically connected to the device body 32 (see FIG. 1) via an electricity supply wire 33 (see FIG. 4). Via the antenna 31, the antenna device 3 transmits and receives a radio wave as a communication medium to and from the RF tag 911 (see FIG. 7A) located in the reading space 27 as an inside space of the guide 22 to perform wireless communication.

The device body 32 shown in FIG. 1 is configured to adjust the intensity (radio wave intensity) of a radio wave for communication with the RF tag 911 (see FIG. 7A).

As illustrated in FIG. 3, while the relative positional relationship between the communication area of the antenna 31 and the RF tag 911 (see FIG. 7A) changes in the reading space 27 of the guide 22, the antenna device 3 performs wireless communication with the RF tag 911 via the antenna 31 to read a piece of goods information from the RF tag 911. The communication area of the antenna 31 is an area which is defined in the periphery of the antenna 31 and in which the wireless communication with the RF tag 911 is possible.

In the present embodiment, when the RF tag 911 moves in the reading space 27 of the guide 22, the antenna device 3 performs wireless communication with the RF tag 911 via the antenna 31 to read a piece of goods information from the RF tag 911.

(2.7) Counter Desk

As illustrated in FIG. 1, the counter desk 8 accommodates the bagging device 2, the antenna device 3, the management device 41 of the sales system 4, and the bag feeding device 5. As illustrated in FIG. 6, the counter desk 8 forms an outer wall located on an opposite side of the guide 22 as the inner wall from the reading space 27. The peripheral space 83 is formed between the guide 22 and the counter desk 8.

As illustrated in FIGS. 1 and 4, the counter desk 8 has the recess 82 which is open at a substantially central portion in a width direction (left-and-right direction) of the upper surface 81. The recess 82 forms the bagging space S1. Note that in the example of FIGS. 1 and 4, although the shopping basket 92 is put in the recess 82 (i.e., the bagging space S1), the shopping basket 92 is not fixed to the counter desk 8, because when moving in the store, customers are to carry the shopping basket 92 by their hand or carry the shopping basket 92 in a shopping cart. Under the recess 82, the bagging device 2 is installed.

Here, as illustrated in FIG. 4, the recess 82 has a bottom which is a shutter 821 which is openable/closeable. When the shutter 821 is in an open state, the placement surface 211 of the bagging device 2 is exposed at the recess 82. The placement surface 211 is located below the recess 82. Thus, when the bottom panel 922 (see FIG. 7A) of the shopping basket 92 placed in the bagging space S1 is opened with the shutter 821 being in the open state, the one or more goods 91 in the shopping basket 92 are released onto the placement surface 211 of the bagging device 2. The bagging device 2 bags the one or more goods 91 placed on the placement surface 211, which will be described in “(3) Operation of Shopping Assistance System” in detail. Thus, bagging of the one or more goods 91 in the shopping basket 92 becomes possible.

Moreover, as illustrated in FIG. 6, the counter desk 8 has a shield function of absorbing or reflecting a radio wave output from the antenna 31. More specifically, the counter desk 8 includes a metal member 85 and a radio wave absorption member 86. The radio wave absorption member 86 is disposed on an inner surface of the metal member 85.

The counter desk 8 has a plurality of (in the example shown in the figure, four) outer wall holes 84. Each of the plurality of outer wall holes 84 is smaller than each of the holes 261 to 266 (see FIG. 3) in the guide 22. As illustrated in FIG. 6, each of the outer wall holes 84 has a length L2 shorter than the length L1 of the hole 261.

(2.8) Bag Feeding Device

The bag feeding device 5 shown in FIG. 1 is a device configured to feed a bag 7 (see FIG. 7A) to the bagging device 2. The bag feeding device 5 is disposed on the right side of the bagging device 2 as viewed from the front side of the counter desk 8. The bag feeding device 5 takes a bag 7 one by one from a bag storage in which a plurality of bags 7 are stored. The bag feeding device 5 feeds, to the bagging device 2, the bag 7 taken out. In the present embodiment, the management device 41 controls the bag feeding device 5 in an interlocked manner with the bagging device 2 so that always one bag 7 is set on (provided to) the bagging device 2. That is, the bagging device 2 is configured to perform the bagging by using one bag 7 fed from the bag feeding device 5. Each time the bagging is performed by the bagging device 2, one new bag 7 is fed from the bag feeding device 5 to the bagging device 2 in preparation for the next bagging. In other words, the bag feeding device 5 starts feeding a bag 7 to the bagging device 2 when the bagging by the bagging device 2 is completed.

(2.9) Driving Device

The driving device 6 shown in FIG. 2 is a device configured to drive the bottom panel 922 (see FIG. 7A) of the shopping basket 92 and the shutter 821 (see FIG. 7A) which will be described later. In the present embodiment, the management device 41 (see FIG. 1) controls the driving device 6 in an interlocked manner with the bagging device 2.

The positional relationship, shapes, and the like of components of the shopping assistance system 100 described above are mere examples and may accordingly be modified. For example, the bagging device 2 and the recess 82 may be disposed at one end (left end or right end) in the width direction (left-and-right direction) of the counter desk 8.

(3) Operation of Shopping Assistance System

Next, the operation of the shopping assistance system 100 according to the present embodiment will be described with reference to FIGS. 7A to 9B. FIGS. 7A to 9B schematically illustrate the operation of the information acquisition system 1 in the shopping assistance system 100. The device body 32, the bag feeding device 5, the holding mechanism 212, and the like are accordingly omitted.

FIGS. 7A to 7C show a process of accommodating the one or more goods 91 into the bag 7 when the relative positional relationship between the placement section 21 and the guide 22 changes from the first state to the second state. In FIGS. 7A to 7C, a plurality of goods 91 such as PET-bottled beverage, boxed confectionery, and canned drink are illustrated, but the number of goods 91 may be one.

First, when the relative positional relationship between the placement section 21 and the guide 22 is in the first state as illustrated in FIG. 7A, the bag 7 is put on the placement section 21 and the guide 22 with a bag opening 71 facing downward, and the bottom part 72 of the bag 7 is supported by the placement surface 211. A stand by state of the bagging device 2 is the state shown in FIG. 7A, and the bagging device 2 remains in the stand by state until the shopping basket 92 in which the goods 91 have been put is placed in the bagging space S1 (in the recess 82) on the placement surface 211. In the present embodiment, in the standby state, the shutter 821 forming the bottom of the recess 82 is in the open state. Note that in the standby state, the shutter 821 may be in a closed state. In this case, to avoid interference of the shutter 821 with the placement section 21, the location of the placement section 21 in the standby state is slightly below the state shown in FIG. 7A. In this case, after the shutter 821 is opened, the placement section 21 may be elevated by the thickness of the shutter 821 to fill the gap between the bottom panel 922 of the shopping basket 92 and the placement surface 211.

Then, when the shopping basket 92 is placed in the bagging space S1 (in the recess 82), the bagging device 2 starts a bagging process. When the bagging process is started, as illustrated in FIG. 7B, the bottom panel 922 of the shopping basket 92 is opened, thereby releasing the goods 91 in the shopping basket 92 onto the placement surface 211 of the bagging device 2. Thus, the goods 91 are put on the bag 7 on the placement surface 211. Here, the bottom part 72 is held on the placement surface 211 by holding force of a holding mechanism 212 (see FIG. 4) in addition to the weight of the goods 91. Then, in the state shown in FIG. 7B, the antenna device 3 outputs a radio wave from the antenna 31 and starts reading pieces of goods information from the RF tags 911.

From the state (first state), the elevator unit 23 moves the placement section 21 downward relative to the guide 22, so that the bag 7 is gradually drawn into the inner side of the guide 22 as illustrated in FIG. 7C. At this time, a side peripheral part 73 of the bag 7 which is continuous to the bottom part 72 of the bag 7 is drawn into the inner side of the guide 22 while the side peripheral part 73 is squeezed by the upper end surface of the guide 22. Thus, the guide 22 around the placement section 21 raises the side peripheral part 73 of the bag 7 from the outer periphery of the bottom part 72.

In this embodiment, even after the goods 91 are accommodated in the inner side of the guide 22, the bottom panel 922 of the shopping basket 92 remains open. The goods 91 are accommodated in the reading space 27 of the guide 22. The antenna device 3 continues reading the pieces of goods information.

In the state shown in FIG. 7C, the elevator unit 23 moves the placement section 21 to change the relative positional relationship between each of the RF tags 911 and a communication area which is defined in the periphery of the antenna 31 and in which wireless communication with each RF tag 911 is possible. In sum, the antenna 31 outputs a radio wave, and thereby, a communication area in which wireless communication with the RF tags 911 is possible is set at least within a range in which the radio wave reaches in the periphery of the antenna 31. The placement section 21 moves relative to the guide 22 provided with the antenna 31, and thereby, the location of each of the goods 91 relative to the communication area changes. That is, in the state shown in FIG. 7C, the antenna device 3 reads the pieces of goods information from the RF tags 911 when the relative positional relationship between each of the RF tags 911 and the communication area defined in the periphery of the antenna 31 changes.

When the relative positional relationship between the placement section 21 and the guide 22 transitions to the second state as illustrated in FIG. 8A, the bag 7 is, in the reading space 27 surrounded by the guide 22, turned inside out from the state shown in FIG. 7A, so that the goods 91 are stored in the bag 7. At this time, the side peripheral part 73 is in a raised state along the inner periphery of the guide 22. Here, the bagging device 2 is configured such that in the second state, a level difference from the placement surface 211 to the upper end surface of the guide 22 is larger than or equal to the total length of the bag 7 in the up-and-down direction. Herein “the total length of the bag 7 in the up-and-down direction” refers to a total length including a pair of handles 74 of the bag 7, that is, a dimension from the bottom part 72 of the bag 7 to tips of the handles 74. Thus, the bag 7 inclusive of the tips of the handles 74 is fit in the reading space 27 surrounded by the guide 22. Thus, the bag 7 inclusive of not only the side peripheral part 73 but also the handles 74 is in the raised state.

Thereafter, as illustrated in FIG. 8B, the bottom panel 922 of the shopping basket 92 is closed. The bagging device 2 moves the placement section 21 upward relative to the guide 22 by using the elevator unit 23. At this time, the antenna device 3 may continue or finish reading the pieces of goods information. Here, the bottom panel 922 of the shopping basket 92 is preferably made of a material having a shield function of absorbing or reflecting a radio wave output from the antenna 31. In the state shown in FIG. 8B, the bagging process by the bagging device 2 is completed. When the bagging process is completed, the antenna device 3 terminates communication with the RF tags 911 to finish reading of the pieces of goods information and transmits the pieces of goods information acquired to the sales system 4 (see FIG. 2). Note that when the elevator unit 23 arrives at the lowest position, the antenna device 3 may terminate reading.

Here, in the state shown in FIG. 8B, the elevator unit 23 moves the placement section 21 to change the relative positional relationship between each of the RF tags 911 and a communication area which is defined in the periphery of the antenna 31 and in which wireless communication with each RF tag 911 is possible. That is, in the state shown in FIG. 8B, the antenna device 3 reads the pieces of goods information from the RF tags 911 when the relative positional relationship between each of the RF tags 911 and the communication area defined in the periphery of the antenna 31 changes.

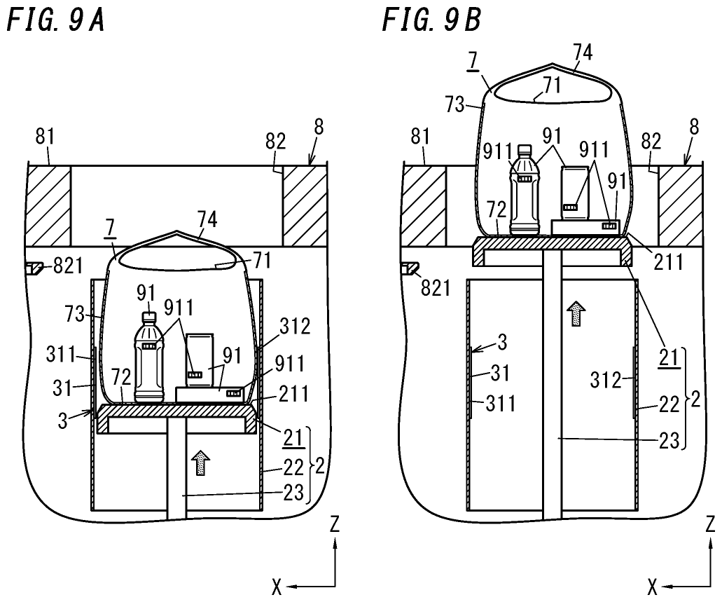

Then, the bagging device 2 drives the placement section 21 by using the elevator unit 23 to change the relative positional relationship between the placement section 21 and the guide 22 from the second state to the first state, thereby releasing the bag 7 from the reading space 27 surrounded by the guide 22. In this example, the shopping basket 92 is removed from the bagging device 2 in the process shown in FIG. 9A, but the shopping basket 92 may be removed before the process shown in FIG. 9A.

That is, the bag 7 on the placement surface 211 protrudes upward from an upper opening of the guide 22 while the placement section 21 is moving upward as shown in FIG. 9A. The placement section 21 further moves upward, and thereby the bag 7 is completely exited from the reading space 27 surrounded by the guide 22 as shown in FIG. 9B. At this time, the bag 7 inclusive of the handles 74 maintains an independent position. Alternatively, the bag 7 fed from the bag feeding device 5 (see FIG. 1) in a state shown in FIG. 7A is turned inside out to accommodate the goods 91. Thus, when characters or the like are printed on the bag 7, mirror printing is preferably adopted.

(4) Effects

In the information acquisition system 1 of the present embodiment, the reflective layers 225 to 228 of the guide 22 (inner wall) have the holes 261 to 266 penetrating through two surfaces in the thickness direction of the reflective layers 225 to 228. This enables a reduction of leakage of a radio wave from sites (e.g., upper sides) other than the holes 261 to 266 in the guide 22. Moreover, since forming the holes 261 to 266 in the guide 22 reduces the area of metal of the reflective layers 225 to 228 of the guide 22, it is possible to reduce null points of the radio wave. Alternatively, when the reflective layers 225 to 228 are formed as innermost layers, it is possible to reduce the contact surface area between the metal and the RF tag 911. Consequently, for example, it is possible to improve reliability of reading of tag information from the RF tag 911 without closing the bottom panel 922 of the shopping basket 92 and the shutter 821 and without increasing transmission power from the antenna 31. That is, it is possible to realize at least one of an improvement of a reading ratio and a reduction of a misreading ratio of the tag information from the RF tag 911.

In the information acquisition system 1 of the present embodiment, the inner wall includes the placement section 21 and the guide 22. At least one item of goods 91 (item) is to be placed on the placement section 21. The guide 22 is disposed around the placement section 21. Thus, it is possible to stably acquire tag information from the RF tag 911 attached to the at least one item of goods 91.

In the information acquisition system 1 of the present embodiment, the spacer 24 (insulating layer) is provided on at least part of the guide 22 (inner wall). The spacer 24 is located between the reading space 27 and the reflective layers 225 to 228. This reduces contact sections between the RF tag 911 and the guide 22, so that it is possible to improve the reading ratio of the tag information. Moreover, although the guide 22 has the holes 261 to 266, it is possible to reduce the incidence of the at least one item of goods 91 (item) going out of the reading space 27 to the outside of the guide 22.

In the information acquisition system 1 of the present embodiment, each of the holes 261 to 266 has a length L1 longer than ½ of a wavelength of the radio wave. This enables the radio wave to be efficiently leaked through the holes 261 to 266, and therefore, it is possible to reduce the ratio of leakage of the radio wave from the a site (e.g., upper sides) other than the holes 261 to 266 in the guide 22 (inner wall).

In the information acquisition system 1 of the present embodiment, the radio wave absorption member 28 is disposed on at least part of the guide 22 (inner wall). The radio wave absorption member 28 absorbs the radio wave. This enables the amount of radio wave reflected off the guide 22 to be reduced, and therefore, it is possible to further reduce leakage of the radio wave from the site other than the holes 261 to 266 in the guide 22. As a result, it is possible to further reduce the misreading ratio of the tag information.

In the information acquisition system 1 of the present embodiment, the placement surface 211 is preferably made of a resin (non-metal). This enables the amount of the radio wave reflected off the placement surface 211 to be reduced, and therefore, it is possible to further improve the reading ratio of the tag information. Moreover, in the case of the placement surface 211 being made of metal, the placement surface 211 preferably has a hole as in the case of the side wall 221.

In the information acquisition system 1 of the present embodiment, the counter desk 8 (outer wall) has a shield function of absorbing or reflecting the radio wave. Thus, it is possible to reduce leakage of the radio wave leaked from the guide 22 (inner wall) to the outer wall to the outer side of the outer wall. A shield of the counter desk 8 is preferably performed by the metal member 85 and the radio wave absorption member 86. However, the shield may be performed by one of the metal member 85 and the radio wave absorption member 86. Moreover, the outer wall does not have to be the counter desk 8 that accommodates the bagging device 2, the antenna device 3, the management device 41 of the sales system 4, and the bag feeding device 5 as shown in FIG. 1. The outer wall may be an object simply having a box shape.

The information acquisition system 1 of the present embodiment has the outer wall hole 84 smaller than each of the holes 261 to 266 in the guide 22 (inner wall). Herein, the dimensional relationship between each of the holes 261 to 266 in the guide 22 and the outer wall hole 84 is defined, for example, by the dimensional relationship of the opening area of each of the holes 261 to 266 in the guide 22 and the opening area of the outer wall hole 84. That is, the opening area of each of the holes 261 to 266 in the guide 22 is larger than the opening area of the outer wall hole 84. Thus, it is possible to reduce leakage of the radio wave leaked from the guide 22 to the counter desk 8 (outer wall) to the outer side of the counter desk 8.

In the information acquisition system 1 of the present embodiment, the holes 261 to 264 are formed in the front surface of the antenna 31. This enables the amount of radio wave leaking through the holes 261 to 264 to be increased, and therefore, it is possible to further reduce leakage of the radio wave from the site other than the holes 261 to 264 in the guide (inner wall) 22.

In the shopping assistance system 100 according to the present embodiment, the misreading ratio of the tag information is reduced to be able to accurately perform checkout processing of each of the one or more goods 91 in the reading space 27.

(5) Variation

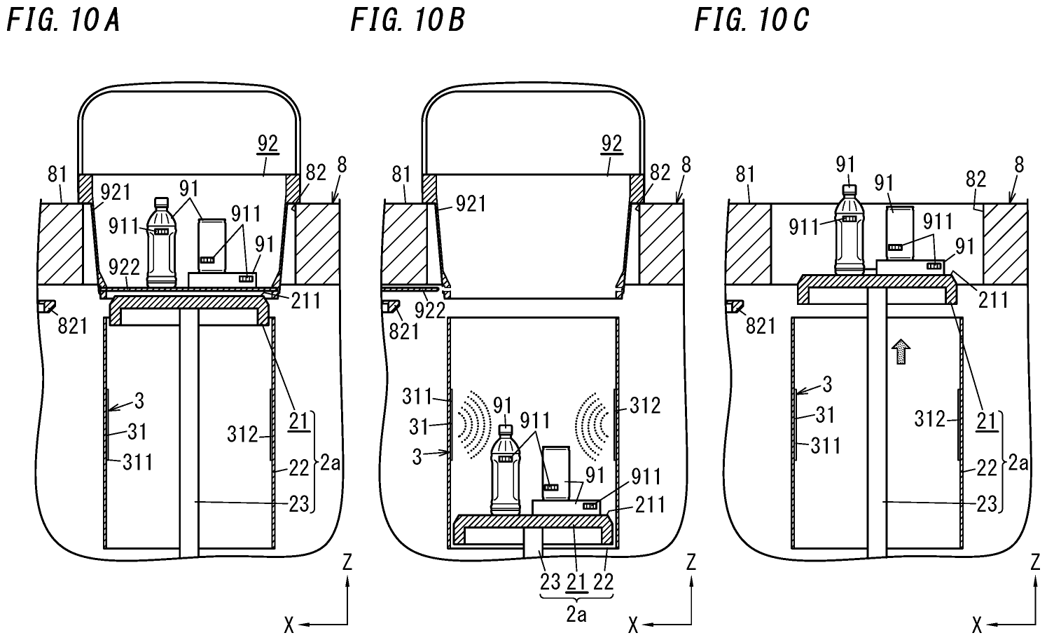

As a first variation of the present embodiment, a shopping assistance system 100 does not have to perform a bagging process of bagging one or more goods 91 in a bag 7 (see FIG. 7C) while an antenna device 3 acquires respective pieces of goods information on the one or more goods 91 as illustrated in FIGS. 10A to 10C. The shopping assistance system 100 includes a displacement device 2a in place of the bagging device 2. The displacement device 2a includes a placement section 21, a guide 22, and an elevator unit 23 in a similar manner to the bagging device 2. Note that the displacement device 2a does not have a function of performing the bagging process. Also in the displacement device 2a, the placement section 21 and the guide 22 form an inner wall.

An operation of the shopping assistance system 100 according to the first variation will be described below. In FIGS. 10A to 10C, the operation of the shopping assistance system 100 according to the first variation is schematically shown, and a device body 32, a bag feeding device 5, and the like are accordingly omitted.

First, as illustrated in FIG. 10A, a shopping basket 92 is placed on a placement surface 211. Here, no bag 7 is put on the placement surface 211. Then, similarly to the present embodiment, a bottom panel 922 of the shopping basket 92 is opened, thereby releasing each of the one or more goods 91 in the shopping basket 92 onto the placement surface 211 (see FIG. 7B). In this state, an antenna device 3 starts reading the respective pieces of goods information from corresponding RF tags 911 attached to the one or more goods 91.

In this state, an elevator unit 23 moves a placement section 21 downward relative to a guide 22 (see FIG. 7C). Also after the one or more goods 91 are accommodated in an inner side of the guide 22, the bottom panel 922 of the shopping basket 92 remains open.

Thereafter, as illustrated in FIG. 10B, the one or more goods 91 are accommodated in a reading space 27 of the guide 22. An opening above an upper surface of the guide 22 remains open. Similarly to the present embodiment, the antenna device 3 may continue or finish reading the respective pieces of goods information.

Thereafter, when the reading of the respective pieces of goods information is continued, the shopping basket 92 and the bottom panel 922 are closed in a similar manner to the present embodiment, and the displacement device 2a moves the placement section 21 upward relative to the guide 22 by using the elevator unit 23 (see FIG. 8B). In this state, the antenna device 3 terminates communication with the RF tags 911 to finish reading the respective pieces of goods information and transmits the respective pieces of goods information acquired to a sales system 4.

Next, as illustrated in FIG. 10C, the displacement device 2a drives the placement section 21 by using the elevator unit 23 to change the relative positional relationship between the placement section 21 and the guide 22 from the second state to the first state, thereby releasing each of the one or more goods 91 from the reading space 27 surrounded by the guide 22.

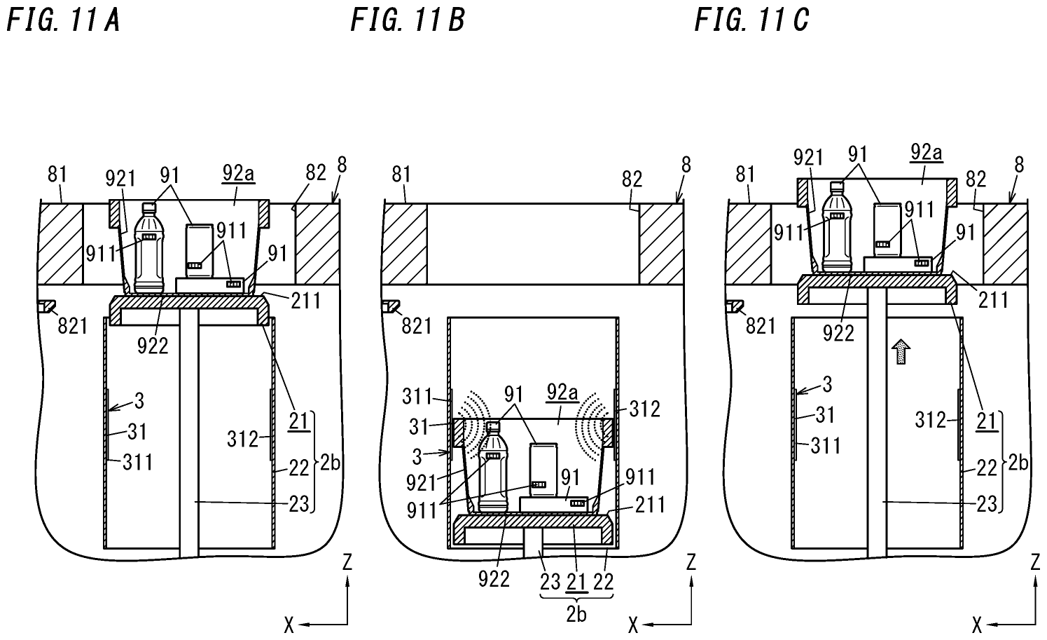

As a second variation of the present embodiment, as illustrated in FIGS. 11A to 11C, a shopping assistance system 100 may move one or more goods 91 together with a shopping basket 92a. The shopping assistance system 100 includes a displacement device 2b in place of the bagging device 2. Similarly to the bagging device 2, the displacement device 2b includes a placement section 21, a guide 22, and an elevator unit 23. However, the displacement device 2b does not have a function of performing a bagging process. Note that also in the displacement device 2b, the placement section 21 and the guide 22 form an inner wall.

The displacement device 2b is configured to move the one or more goods 91 together with the shopping basket 92a to a reading space 27 in the guide 22. Thus, unlike the present embodiment, a bottom panel 922 of the shopping basket 92a in the second variation does not have to be opened and closed. Therefore, in the shopping basket 92a, a basket body 921 and the bottom panel 922 are formed integrally with each other. Moreover, also the shopping basket 92a moves together with the one or more goods 91 to the reading space 27 in the guide 22. Therefore, the shopping basket 92a of the second variation is preferably smaller than the shopping basket 92 of the present embodiment.

An operation of the shopping assistance system 100 according to a second variation will be described below. In FIGS. 11A to 11C, the operation of the shopping assistance system 100 according to the second variation is schematically shown, and a device body 32, a bag feeding device 5, and the like are accordingly omitted.

First, as illustrated in FIG. 11A, a shopping basket 92a is placed on a placement surface 211. Here, no bag 7 is put on the placement surface 211. Then, an antenna device 3 starts reading respective pieces of goods information from corresponding RF tags 911 attached to the one or more goods 91.

In this state, an elevator unit 23 moves a placement section 21 downward relative to a guide 22. The shopping basket 92a, in which the one or more goods 91 have been put, is accommodated in an inner side of the guide 22. At this time, the antenna device 3 continues reading the respective pieces of goods information.

Thereafter, as illustrated in FIG. 11B, the one or more goods 91 are accommodated in a reading space 27 in the guide 22. At this time, the antenna device 3 may continue or finish reading the respective pieces of goods information. Thereafter, when the reading of the respective pieces of goods information is continued, the displacement device 2b moves the placement section 21 upward relative to the guide 22 by using the elevator unit 23. The antenna device 3 terminates communication with the RF tags 911 and transmits the respective pieces of goods information acquired to a sales system 4.

As illustrated in FIG. 11C, the displacement device 2b changes the relative positional relationship between the placement section 21 and the guide 22 from the second state to the first state, thereby releasing the shopping basket 92a accommodating the one or more goods 91 from the reading space 27 surrounded by the guide 22.

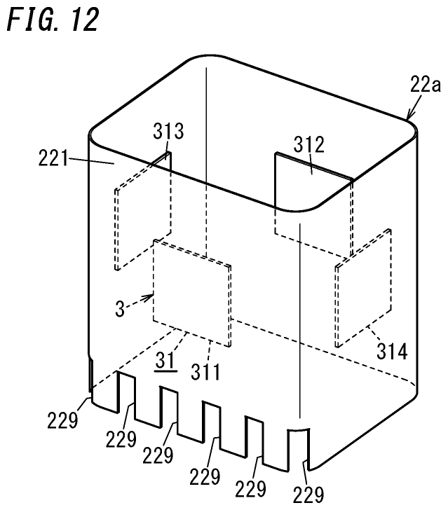

As a third variation of the present embodiment, a shopping assistance system 100 may include a guide 22a as illustrated in FIG. 12 in place of the guide 22 (see FIG. 3). The guide 22a has a plurality of (in the example shown in the figure, six) slits 229. More specifically, a reflective layer 225 of the guide 22a has the plurality of slits 229 as holes connecting a reading space 27 to a peripheral space 83. The plurality of slits 229 are formed in a lower portion of one side wall 221 of the guide 22a. Note that the plurality of slits 229 do not have to be formed in only the one side wall 221 of the guide 22a but may be formed in two or more side walls of the guide 22a. For example, the slits 229 may be formed in all the side walls of the guide 22a. The number of slits 229 is not limited to two or more but may be one.

As illustrated in FIG. 12, the slits 229 formed in the guide 22a enable reflection waves reflected off the side wall 221 of the guide 22a to be reduced. Moreover, it is possible to reduce the incidence of an RF tag 911 coming into contact with the guide 22a. Thus, it is possible to increase the reading ratio of goods information from the RF tags 911.

As a fourth variation of the present embodiment, a shopping assistance system 100 may include a displacement device as described below in place of the bagging device 2. The displacement device according to the fourth variation includes a placement section 21, a guide 22, and an elevator unit 23 in a similar manner to the bagging device 2. The displacement device further includes a projection section as described below. The projection section protrudes upward from a placement surface 211 of the placement section 21 when the relative positional relationship between the placement section 21 and the guide 22 changes from a first state to a second state. Note that also in the displacement device of the fourth variation, the placement section 21 and the guide 22 form an inner wall.

An operation of the shopping assistance system 100 according to the fourth variation will be described below.

First, when the relative positional relationship between the placement section 21 and the guide 22 is in the first state, a shopping basket 92 is placed on the placement surface 211. Here, no bag 7 is put on the placement surface 211. Thereafter, a bottom panel 922 of the shopping basket 92 is opened, thereby releasing goods 91 in the shopping basket 92 onto the placement surface 211 of a bagging device 2. An antenna device 3 starts reading pieces of goods information from corresponding RF tags 911 attached to the goods 91.

In this state, an elevator unit 23 moves the placement section 21 downward relative to the guide 22, and thereby, the projection section disposed in the elevator unit 23 protrudes from the placement surface 211 of the placement section 21. The projection section protruding from the placement surface 211 disperses the goods 91 on the placement surface 211. Thus, it is possible to reduce cases where RF tags 911 of the goods 91 overlap each other or cases where the RF tag 911 of an item of the goods 91 overlaps a metal portion of another item of goods 91. Thus, it is possible to increase the reading ratio of each of the pieces of goods information from the RF tags 911.

Note that an antenna having a line shape may be disposed in the projection section. Thus, it is possible to further increase the reading ratio of pieces of goods information from the RF tags 911.

Moreover, when the goods 91 are bagged in the bag 7 as in the present embodiment, the amount of projection of the projection section may be reduced so that the bag 7 is not broken.

As a fifth variation of the present embodiment, a shopping assistance system 100 may include a mechanism configured to vibrate a placement section 21 in the horizontal direction. That is, the shopping assistance system 100 is configured to vibrate a plurality of goods 91 placed on a placement surface 211.

When an RF tag 911 of an item of goods 91 is in contact with an aluminum package of another item of goods 91, such as a package of potato chips, reading of goods information from the RF tag 911 may become difficult. In this case, the placement surface 211 is vibrated in the horizontal direction, which enables the positional relationship of the two goods 91 to be changed, so that it is possible to prevent the RF tag 911 of an item of goods 91 from being in contact with the aluminum package of another item of goods 91.

As a sixth variation of the present embodiment, a shopping assistance system 100 may include a cover covering a shopping basket 92 placed on a placement surface 211 of a placement section 21.

The cover includes a molding made of a transparent resin and a conductive film stuck on the molding and being transparent. The cover covers at least part of a periphery of the shopping basket 92 placed on the placement surface 211 of the placement section 21. The cover has an opening facing a customer so that the customer is to place the shopping basket 92. Moreover, to retrieve the shopping basket 92, the cover has a recess in a lower part of a back surface located on a far side from a customer.

Providing the cover enables a further reduction in leakage of a radio wave output from the antenna 31 into the guide 22. Moreover, since the cover has a light transmitting property, oppression felt by customers may be reduced even when the cover is provided. The cover may include a metal body reflecting radio waves or may include a radio wave absorber absorbing radio waves.

As a seventh variation of the present embodiment, a shopping assistance system 100 does not have to include the displacement device, and a shopping basket 92 in which goods 91 have been put or goods 91 may be directly placed in a reading space 27.

Note that the guide 22 of the present embodiment has the holes 261 to 264 (see FIG. 3) in only the side wall 221 but may have holes in other side walls 222 to 224. For example, the guide 22 may have holes in the side wall 221 and the side wall 222 facing the side wall 221. Alternatively, the guide 22 may have holes in all the side walls 221 to 224.

Moreover, the guide 22 of the present embodiment has four holes 261 to 264 in the side wall 221, but the guide 22 may have three or fewer holes or five or more holes in the side wall 221. In sum, the guide 22 has at least one hole in the side wall 221.

Similarly, the guide 22 of the present embodiment has the hole 265 (see FIG. 3) in the interface section between the side wall 221 and the side wall 223, and the hole 266 (see FIG. 3) in the interface section between the side wall 221 and the side wall 224, but the guide 22 may have the hole in other sections. For example, the guide 22 may have a hole in the interface section between the side wall 222 and the side wall 223 or may have a hole in the interface section between the side wall 222 and the side wall 224.

Moreover, the guide 22 of the present embodiment has three holes 265 in the interface section between the side wall 221 and the side wall 223, but the guide 22 may have two or fewer holes 265 in the interface section or four or more holes 265 in the interface section. Similarly, the guide 22 of the present embodiment has three holes 266 in the interface section between the side wall 221 and the side wall 224, but the guide 22 may have two or fewer holes 266 in the interface section or four or more holes 266 in the interface section. Note that it is not essential that the guide 22 has the holes 265 and 266.

Note that the bagging device 2 is configured to perform not only bagging of one or more goods 91 in the shopping basket 92 but also bagging of one or more goods 91 which are not in the shopping basket 92. In this case, a customer directly places the one or more goods 91 in the bagging space S1, and thereby, the customer causes the bagging device 2 to bag the one or more goods 91.

Moreover, the antenna 31 includes four patch antennas 311 to 314 (see FIG. 3) but this should not be construed as limiting. The antenna 31 may include three or fewer patch antennas 311 or may include five or more patch antennas 311. Further, a plurality of patch antennas may be disposed on an identical surface of the inner side surfaces of the guide 22 or may be disposed on a pair of surfaces facing each other. The pair of patch antennas disposed on the pair of surfaces facing each other may be in a positional relationship in which the patch antennas are shifted from each other in a direction transverse to a direction in which the patch antennas face each other. Furthermore, the patch antennas 311 to 314 are disposed on the guide 22 but this should not be construed as limiting. The patch antennas 311 to 314 may be disposed on, for example, the placement section 21.

Moreover, a method for forming shields for the shutter 821, the bottom panel 922, the guide 22, the placement section 21, and the like is not limited to metal vapor deposition. For example, the shutter 821, the bottom panel 922, the guide 22, and the placement section 21 themselves may be made of metal to serve also as the shields. Alternatively, metal plates stuck on the shutter 821, the bottom panel 922, the guide 22, the placement section 21, and the like may serve as the shields. Further, for example, at least part of the counter desk 8 (e.g., inner side surface of the recess 82) may be provided with a shield made of metal. The shield is not limited to a shield made of metal. The shield may be, for example, a radio wave absorber that absorbs a radio wave.

Moreover, the antenna 31 is not limited to the patch antenna but may be a monopole antenna, an inverted-F antenna having a plate-like shape, or the like.

Moreover, the RF tag 911 is not limited to the passive-type RF tag but may be an active-type RF tag.

Moreover, a configuration for changing the location of the one or more goods 91 relative to the communication area is not limited to a configuration in which the elevator unit 23 moves the placement section 21. For example, the antenna 31 may be mechanically moved, or the communication area may be moved by beamforming.

Moreover, in the antenna device 3, it is not essential that the radio wave intensity is constant, but the radio wave intensity may be varied.

In this case, the device body 32 is configured to adjust the intensity of a radio wave (radio wave intensity) for communication with the RF tag 911. More specifically, the device body 32 selects and uses one of radio wave intensities corresponding to respective levels such as “strong”, “medium”, and “weak”. The radio wave intensities of these levels and the distance to which the radio wave output from the antenna 31 reaches decreases in the order of “strong”, “medium”, and “weak”. Thus, for example, in the case of the radio wave intensity being “strong”, the radio wave is farther delivered from the antenna 31 than in the case of the radio wave intensity being “weak”, so that the antenna device 3 can communicate with the RF tag 911 located remote from the antenna 31. Moreover, this leads to a reduction of null points.

Moreover, the device body 32 may be configured to change the intensity of the radio wave output from the antenna 31 in accordance with the displacement location of the RF tag 911. For example, the device body 32 is configured to change the radio wave intensity of the antenna 31 in accordance with a member covering an upper opening area of the guide 22, that is, in accordance with a shield property of the reading space 27. When only the bottom panel 922 of the shopping basket 92 covers the upper opening area of the guide 22, the radio wave intensity is set to “medium”. On the other hand, when the bottom panel 922 of the shopping basket 92 and the shutter 821 cover the upper opening area of the guide 22, the radio wave intensity is set to “strong”. Note that when the upper opening area of the guide 22 is covered with neither the bottom panel 922 nor the shutter 821, the radio wave intensity is set to “weak”.

Moreover, the shopping basket 92 may have not only a function of accommodating one or more goods 91 picked up by a customer in a store but also a function of reading pieces of goods information on a plurality goods 91 to transmit the pieces of goods information on the plurality of goods 91 to the sales system 4. The shopping basket 92 configured to read goods information by means of at least one of, for example, an RF tag, a barcode, a two-dimensional code, and image recognition. In this case, in the sales system 4, the pieces of goods information read by the shopping basket 92 and the pieces of goods information acquired by the antenna device 3 are both used to increase the reliability of the pieces of goods information.

Moreover, the shopping assistance system 100 is not limited to use in convenience stores but may be installed in stores other than convenience stores. Furthermore, the information acquisition system 1 may be installed in facilities, such as factories, offices, and delivery centers, other than stores. In facilities other than stores, the pieces of goods information acquired by the antenna device 3 of the shopping assistance system 100 are used for, for example, tracking, quality control, or sorting of goods 91 bagged. That is, when in, for example, a factory, goods 91 manufactured are bagged, pieces of goods information on the goods 91 bagged enables tracking and the like of the goods 91.

Moreover, if in the sales system 4, a contract for the sales process is not concluded, the shopping assistance system 100 does not have to deliver the one or more goods 91 to the customer. For example, the sales system 4 performs a purchase cancellation process in a case where an item of goods 91 such as alcohol which is not allowed to be sold to an underage customer, and in a case where a customer cancels the purchase of one or more goods 91. In this case, the item of goods 91 is not delivered to the customer but is returned to the store.

Moreover, the bagging device 2 is at least configured to put one or more goods 91 into the bag 7 and may be configured to put (bag) the one or more goods 91 into a bag 7 which is not limited to the shopping bag as described above but which is, for example, a reusable shopping bag, or a net bag. A material for a shopping bag is not limited to polyethylene but may be polypropylene, or the like.

Moreover, the shopping assistance system 100 does not have to be used together with the sales system 4 which enables purchase of one or more goods 91 without operation by a clerk as illustrated in the case of the embodiment. For example, the shopping assistance system 100 may be used in a situation in which a clerk is at a checkout counter as in the case of a so-called manned checkout counter.

The configuration in which for example, the information acquisition system 1 and the sales system 4 are disposed inside one housing (counter desk 8) is not an essential configuration of the shopping assistance system 100. Components of the shopping assistance system 100 may be distributed to be provided in a plurality of housings.

Moreover, the bag feeding device 5 may be configured to turn inside out the bag 7 and then supply the bag 7 to the bagging device 2. In this case, the bag 7 is turned inside out and is put on the bagging device 2, and is turned out again to accommodate the one or more goods 91. Therefore, the initial outer surface of the bag 7 is the outer surface of the bag 7 in which the one or more goods 91 are stored. Thus, when characters and like are printed on the bag 7, it is not necessary to adopt bags 7 on which mirror printing has been performed.

Moreover, in the embodiment, the holding mechanism 212 of the bagging device 2 clips the bottom part 72 of the bag 7 to hold the bottom part 72, but this configuration should not be construed as limiting. The bottom part 72 may be held on the placement surface 211 through suction by, for example, a vacuum suction pad.

Moreover, when a plurality of types of bags 7 different in size, color, or the like are adopted, the bag feeding device 5 is preferably configured to select one bag 7 from the plurality of types of bags 7 as needed, and to feed the bag 7 selected to the bagging device 2.

Alternatively, the bagging device 2 may be configured to move, for example, the guide 22, but not the placement section 21, to change the relative positional relationship between the placement section 21 and the guide 22 from a first state to a second state. The bagging device 2 may be configured to move, for example, both the placement section 21 and the guide 22 to change the relative positional relationship between the placement section 21 and the guide 22 from the first state to the second state.

Moreover, a configuration in which the shopping basket 92 has the basket body 921 and the bottom panel 922 is not an essential configuration for the shopping assistance system 100. The configuration of the shopping basket 92 may be accordingly modified. For example, the shopping basket 92 may be configured to release each of the one or more goods 91 in the shopping basket 92 when the entirety of the shopping basket 92 is tilted.

Moreover, it is not an essential configuration for the shopping assistance system 100 that the sales system 4 (management device 41) is capable of communicating with the store terminal. The sales system 4 does not have to be able to communicate with the store terminal. For example, the sales system 4 itself may have a function of performing the checkout process of the one or more goods 91 based on the respective pieces of goods information.

Moreover, the shopping basket 92 is not limited to the configuration held by a hand of a customer but may include a basket body 921 integrated with, for example, a cart.

Various modifications described above may be combined as appropriate.

Aspects

As described above, an information acquisition system (1) of a first aspect of the present invention includes an inner wall (placement section 21, a guide 22; 22a), an outer wall (counter desk 8), and an antenna (31). The inner wall includes reflective layers (225 to 228) which reflect a radio wave. A reading space (27) is located on an inner side of the reflective layers (225 to 228). The reading space (27) is a space for reading of tag information from an RF tag (911) attached to an item (an item of goods 91). The outer wall is located on an opposite side of the inner wall from the reading space (27). The antenna (31) is configured to output the radio wave toward the reading space (27) in order to communicate with the RF tag (911). The reflective layer (225) of the inner wall has holes (261 to 266; slits 229). The holes (261 to 266; slits 229) connect the reading space (27) to a peripheral space (83) provided between the inner wall and the outer wall.

The information acquisition system (1) of the first aspect enables a reduction of leakage of a radio wave from sites (e.g., upper sides) other than the holes (261 to 266; slits 229) in the inner wall (guides 22; 22a). Moreover, since forming the holes (261 to 266; slits 229) in the inner wall reduces the area of metal of the reflective layers (225 to 228) of the inner wall, it is possible to reduce null points of the radio wave. Alternatively, when the reflective layers (225 to 228) are formed as innermost layers, it is possible to reduce the contact surface area between the metal and the RF tag (911). Consequently, for example, it is possible to improve reliability of reading of tag information from the RF tag (911) without closing the bottom panel (922) of the shopping basket (92; 92a) and a shutter (821) and without increasing transmission power from the antenna (31). That is, it is possible to realize at least one of an improvement of a reading ratio and a reduction of a misreading ratio of the tag information from the RF tag (911).

In an information acquisition system (1) of a second aspect referring to the first aspect, the inner wall further includes a placement section (21) and a guide (22; 22a). The placement section (21) has a placement surface (211) on which an item (an item of goods 91) is to be placed. The reading space (27) is located on an inner side of the guide (22; 22a). The guide (22; 22a) extends along an outer periphery of the placement surface (211) to be disposed around the placement section (21).

The information acquisition system (1) of the second aspect enables stable acquisition of tag information from the RF tag (911) attached to the item.

An information acquisition system (1) of a third aspect referring to the first or second aspect further includes an insulating layer (spacer 24). The insulating layer is provided on at least part of the inner wall (guide 22; 22a). The insulating layer is located between the reading space (27) and the reflective layers (225 to 228).

The information acquisition system (1) of the third aspect reduces contact sections between the RF tag (911) and the inner wall (guide 22; 22a), so that it is possible to improve the reading ratio of the tag information. Moreover, although the reflective layers (225 to 228) of the inner wall have the holes (261 to 266; slits 229), it is possible to reduce the incidence of the item (at least one item of goods 91) going out of the reading space (27) to the outside of the inner wall.

In an information acquisition system (1) of a fourth aspect referring to any one of the first to third aspects, each of the holes (261 to 266; slits 229) has a length (L1) longer than ½ of a wavelength of the radio wave.

The information acquisition system (1) of the fourth aspect enables the radio wave to be efficiently leaked through the holes (261 to 266; slits 229), and therefore, it is possible to reduce the ratio of leakage of the radio wave from a site (e.g., upper sides) other than the holes (261 to 266; slits 229) in the inner wall (guide 22; 22a).

An information acquisition system (1) of a fifth aspect referring to any one of the first to fourth aspects further includes a radio wave absorption member (28). The radio wave absorption member (28) is disposed on at least part of the inner wall (guide 22; 22a) and has an absorption function of absorbing the radio wave output from the antenna (31).

The information acquisition system (1) of the fifth aspect enables the amount of radio wave reflected off the inner wall (guide 22; 22a) to be reduced, and therefore, it is possible to further reduce leakage of the radio wave from the site other than the holes (261 to 266; slits 229) in the inner wall. As a result, it is possible to further reduce the misreading ratio of the tag information.

In an information acquisition system (1) of a sixth aspect referring to the second aspect, the placement surface (211) is made of a resin.

The information acquisition system (1) of the sixth aspect enables the amount of the radio wave reflected off the placement surface (211) to be reduced, and therefore, it is possible to further improve the reading ratio of the tag information.

In an information acquisition system (1) of a seventh aspect referring to any one of the first to sixth aspects, the outer wall (counter desk 8) has a shield function of absorbing or reflecting the radio wave output from the antenna (31).

According to the information acquisition system (1) of the seventh aspect, it is possible to reduce leakage of the radio wave, which has leaked from the inner wall (guide 22; 22a) to the outer wall (counter desk 8), to the outer side of the outer wall.

In an information acquisition system (1) of an eighth aspect referring to any one of the first to seventh aspects, the outer wall (counter desk 8) has an outer wall hole (84) smaller than each of the holes (261 to 266; slits 229) in the inner wall (guide 22; 22a).

According to the information acquisition system (1) of the eighth aspect, it is possible to reduce leakage of the radio wave, which has leaked from the inner wall (guide 22; 22a) to the outer wall (counter desk 8), to the outer side of the outer wall.

In an information acquisition system (1) of a ninth aspect referring to any one of the first to eighth aspects, the holes (261 to 264) are formed in a front surface of the antenna (31).

The information acquisition system (1) of the ninth aspect enables the amount of radio wave leaking through the holes (261 to 264) to be increased, and therefore, it is possible to further reduce leakage of the radio wave from the site other than the holes in the inner wall (guide 22).

In an information acquisition system (1) of a tenth aspect referring to the ninth aspect, the antenna (31) includes a first patch antenna (patch antenna 311) and a second patch antenna (patch antenna 312) which face each other. The holes (261 to 264) are formed in a front surface of the second patch antenna to be located in a periphery of a location where the first patch antenna is attached.

In an information acquisition system (1) of an eleventh aspect referring to the tenth aspect, the holes (261 to 264) are at least four holes. The at least four holes (261 to 264) include two first holes (hole 261 and 262) and two second holes (holes 263 and 264). In a first direction orthogonal to a direction in which the first patch antenna (patch antenna 311) and the second patch antenna (patch antenna 312) face each other, the two first holes are located on opposing sides of the location to which the first patch antenna is attached. In a second direction orthogonal to both the first direction and the direction in which the first patch antenna and the second patch antenna face each other, the two second holes are located on opposing sides of the location to which the first patch antenna is attached.

In an information acquisition system (1) of a twelfth aspect referring to any one of the first to eleventh aspects, in an upper portion of the reading space (27), a shopping basket (92) is to be placed. The shopping basket (92) includes a bottom panel (922) having a shield function of absorbing or reflecting the radio wave output from the antenna (31).

According to the information acquisition system (1) of the twelfth aspect, even when a radio wave from the antenna (31) leaks, it is possible to shield the radio wave by the bottom panel (922) of the shopping basket (92), and therefore, it is possible to further increase the reliability of reading of the tag information from the RF tag (911).

In an information acquisition system (1) of a thirteenth aspect referring to the second aspect, the guide (22) includes a plurality of side walls (221 to 224). The hole (265; 266) is formed in an interface section between two side walls (221, 223; 221, 224) of the plurality of side walls (221 to 224).

In an information acquisition system (1) of a fourteenth aspect referring to the thirteenth aspect, the antenna (31) includes a first patch antenna (patch antenna 311) and a second patch antenna (patch antenna 312) which face each other. The holes (261 to 266) are plurality of holes. The plurality of holes (261 to 266) includes at least one hole that is formed in an interface section between the two side walls (221, 223; 221, 224) and at least one hole that is in a front surface of the second patch antenna to be located in a periphery of a location to which the first patch antenna is attached.

In an information acquisition system (1) of a fifteenth aspect referring to the second aspect, the guide (22a) includes a plurality of side walls (221 to 224). The reflective layer (225) has at least one slit (229) as a hole. The hole is formed in at least one of the plurality of side walls (221 to 224).

In an information acquisition system (1) of a sixteenth aspect referring to the first aspect, the antenna (31) includes a first patch antenna (patch antenna 311) and a second patch antenna (patch antenna 312) which face each other.

In an information acquisition system (1) of a seventeenth aspect referring to the sixteenth aspect, the antenna (31) further includes a third patch antenna (patch antenna 313) and a fourth patch antenna (patch antenna 314). The third patch antenna and the fourth patch antenna face each other in a direction different from a direction in which the first patch antenna (patch antenna 311) and the second patch antenna (patch antenna 312) face each other.

A shopping assistance system (100) of an eighteenth aspect includes the information acquisition system (1) of any one of first to seventeenth aspect, and a checkout processing system (sales system 4). The checkout processing system is configured to perform checkout processing of one or more goods each defined as the item (an item of goods 91) in the reading space (27).

The shopping assistance system (100) of the eighteenth aspect enables a reduction of leakage of a radio wave from sites (e.g., upper sides) other than the holes (261 to 266; slits 229) in the inner wall (guides 22; 22a). Moreover, since forming the holes (261 to 266; slits 229) in the inner wall reduces the metal area of the reflective layer (225) of the inner wall, it is possible to reduce null points of the radio wave. Alternatively, when the reflective layer (225) is formed as an innermost layer, it is possible to reduce the contact surface area between metal and the RF tag (911). Consequently, for example, it is possible to improve reliability of reading of tag information from the RF tag (911) without closing the bottom panel (922) of the shopping basket (92; 92a) and the shutter (821) and without increasing transmission power from the antenna (31). Moreover, the reliability of the reading of the tag information is increased to be able to accurately perform checkout processing of each of the one or more goods (91) in the reading space (27).

An information acquisition device (bagging device 2, antenna device 3) of a nineteenth aspect is to be used in the information acquisition system (1) of any one of the first to seventeenth aspects. The information acquisition device includes an inner wall (the placement section 21, the guide 22; 22a) and the antenna (31). The reflective layer of the inner wall has holes (261 to 266; slits 229).

The information acquisition device (bagging device 2, antenna device 3) of the nineteenth aspect enables a reduction of leakage of a radio wave from sites (e.g., upper sides) other than the holes (261 to 266; slits 229) in the inner wall (guides 22; 22a). Moreover, since forming the holes (261 to 266; slits 229) in the inner wall reduces the metal area of the reflective layer (225) of the inner wall, it is possible to reduce null points of the radio wave. Alternatively, when the reflective layer (225) is formed as an innermost layer, it is possible to reduce the contact surface area between metal and the RF tag (911). Consequently, for example, it is possible to improve reliability of reading of tag information from the RF tag (911) without closing the bottom panel (922) of the shopping basket (92; 92a) and the shutter (821) and without increasing transmission power from the antenna (31).

A shopping assistance method according to a twentieth aspect includes acquiring respective pieces of goods information on one or more goods (91) each defined as the item put in the reading space (27) by using the information acquisition system (1) of any one of the first to seventeenth aspects. The shopping assistance method includes performing, based on the respective pieces of goods information, checkout processing of the one or more goods (91) in the reading space (27) by using the checkout processing system (sales system 4).

The shopping assistance method according to the twentieth aspect enables a reduction of leakage of a radio wave from sites (e.g., upper sides) other than the holes (261 to 266; slits 229) in the inner wall (guides 22; 22a). Moreover, since forming the holes (261 to 266; slits 229) in the inner wall reduces the metal area of the reflective layer (225) of the inner wall, it is possible to reduce null points of the radio wave. Alternatively, when the reflective layer (225) is formed as an innermost layer, it is possible to reduce the contact surface area between metal and the RF tag (911). Consequently, for example, it is possible to improve reliability of reading of tag information from the RF tag (911) without closing the bottom panel (922) of the shopping basket (92; 92a) and the shutter (821) and without increasing transmission power from the antenna (31). Moreover, the reliability of the reading of the tag information is increased to be able to accurately perform checkout processing of each of the one or more goods (91) in the reading space (27).

1. An information acquisition system, comprising:
an inner wall having a reflective layer which reflects a radio wave, a reading space for reading of tag information from an RF tag attached to an item being located on an inner side of the reflective layer;
an outer wall located on an opposite side of the inner wall from the reading space; and
an antenna configured to output the radio wave toward the reading space in order to communicate with the RF tag,
the reflective layer of the inner wall having at least one hole connecting the reading space to a peripheral space provided between the inner wall and the outer wall.

2. The information acquisition system of claim 1, wherein
the inner wall includes:
a placement section, the placement section having a placement surface on which the item is to be placed; and
a guide, the guide extending along an outer periphery of the placement surface to be disposed around the placement section, the reading space being located on an inner side of the guide.

3. The information acquisition system of claim 1 further comprising an insulating layer disposed on at least part of the inner wall, the insulating layer being located between the reading space and the reflective layer.

4. The information acquisition system of claim 1, wherein
the at least one hole has a length longer than ½ of a wavelength of the radio wave.

5. The information acquisition system of claim 1 further comprising a radio wave absorption member disposed on at least part of the inner wall, the radio wave absorption member having an absorption function of absorbing the radio wave output from the antenna.

6. The information acquisition system of claim 2, wherein
the placement surface is made of a resin.

7. The information acquisition system of claim 1, wherein
the outer wall has a shield function of absorbing or reflecting the radio wave output from the antenna.

8. The information acquisition system of claim 1, wherein
the outer wall has an outer wall hole smaller than the at least one hole in the inner wall.

9. The information acquisition system of claim 1, wherein
the at least one hole is formed in a front surface of the antenna.

10. The information acquisition system of claim 9, wherein
the antenna includes a first patch antenna and a second patch antenna which face each other, and
the at least one hole is formed in a front surface of the second patch antenna to be located in a periphery of a location where the first patch antenna is attached.

11. The information acquisition system of claim 10, wherein
the at least one hole includes at least four holes,
the at least four holes include:
two first holes, in a first direction orthogonal to a direction in which the first patch antenna and the second patch antenna face each other, the two first holes being located on opposing sides of the location to which the first patch antenna is attached; and
two second holes, in a second direction orthogonal to both the first direction and the direction in which the first patch antenna and the second patch antenna face each other, the two second holes being located on opposing sides of the location to which the first patch antenna is attached.

12. The information acquisition system of claim 1, wherein
in an upper portion of the reading space, a shopping basket is to be placed, and
the shopping basket includes a bottom panel having a shield function of absorbing or reflecting the radio wave output from the antenna.

13. The information acquisition system of claim 2, wherein
the guide has a plurality of side walls,
the at least one hole is formed in an interface section between two side walls of the plurality of side walls.

14. The information acquisition system of claim 13, wherein
the antenna includes a first patch antenna and a second patch antenna which face each other,
the at least one hole includes a plurality of holes, and
the plurality of holes include:
at least one hole that is formed in an interface section between the two side walls; and
at least one hole that is in a front surface of the second patch antenna to be located in a periphery of a location to which the first patch antenna is attached.

15. The information acquisition system of claim 2, wherein
the guide has a plurality of side walls,
the reflective layer has at least one slit as the at least one hole, and
the at least one hole is formed in at least one of the plurality of side walls.

16. The information acquisition system of claim 1, wherein
the antenna includes a first patch antenna and a second patch antenna which face each other.

17. The information acquisition system of claim 16, wherein
the antenna further includes a third patch antenna and a fourth patch antenna, and
the third patch antenna and the fourth patch antenna face each other in a direction different from a direction in which the first patch antenna and the second patch antenna face each other.

18. A shopping assistance system, comprising:
the information acquisition system of claim 1; and
a checkout processing system configured to perform checkout processing of one or more goods each defined as the item in the reading space.

19. An information acquisition device to be used in the information acquisition system of claim 1, the information acquisition device comprising:
the inner wall; and
the antenna, wherein
the reflective layer of the inner wall has at least one hole connecting the reading space to the peripheral space.

20. A shopping assistance method, comprising:
acquiring respective pieces of goods information on one or more goods each defined as the item put in the reading space by using the information acquisition system of claim 1; and
performing, based on the respective pieces of goods information, checkout processing of the one or more goods in the reading space by using a checkout processing system.
